(19) United States
(12) Patent Application Publication
(10) Pub. No.: US 2022/0013118 A1
(43) Pub. Date: Jan. 13, 2022

(54) INAUDIBLE VOICE COMMAND INJECTION

(71) Applicants: Chulsoon Hwang, Rolla, MO (US); Zhifei Xu, Rolla, MO (US); Jun Fan, Rolla, MO (US)

(72) Inventors: Chulsoon Hwang, Rolla, MO (US); Zhifei Xu, Rolla, MO (US); Jun Fan, Rolla, MO (US)

(73) Assignee: The Curators of the University of Missouri, Columbia, MO (US)

(21) Appl. No.: 17/349,268

(22) Filed: Jun. 16, 2021

Related U.S. Application Data
(60) Provisional application No. 63/049,419, filed on Jul. 8, 2020.

(51) Int. Cl. G10L 15/22; G10L 25/03; G10L 25/78

(52) U.S. Cl. CPC G10L 15/22; G10L 25/78; G10L 25/03

(57) ABSTRACT

Methods and system for testing a voice-enabled device. A signal generator generates a carrier signal having a variable resonant frequency, and a frequency mixer mixes an audible voice command signal with the carrier signal to generate an inaudible amplitude-modulated test signal. An antenna transmits the amplitude-modulated test signal at a variable attack angle to a voice-enabled device. The resonant frequency of the carrier signal and/or the attack angle of the transmitted amplitude-modulated signal are varied and at least one of a sensitive frequency and a sensitive attack angle of the voice-enabled device is identified.

### CROSS-REFERENCE TO RELATED APPLICATION

This application claims priority from U.S. Provisional Patent Application No. 63/049,419, filed Jul. 8, 2020, the entire disclosure of which is incorporated herein by reference.

### FIELD

Aspects of the present disclosure relate to inaudible voice command injection using intentional electromagnetic interference (EMI) for voice-enabled electronic devices.

### BACKGROUND

Voice-enabled devices, including smart speakers (e.g., Google Home® and Amazon Echo®), are more than music players. For example, voice-enabled devices can serve as “home assistants” that provide control of network-connected devices for managing various household tasks, such as environmental control (thermostat), lighting, door locks, and security monitoring.

Security of voice-enabled devices is of critical importance to prevent breaches of home security and leaks of private information. Wi-Fi and Bluetooth connections provide opportunities for attacks on conventional voice-enabled devices through apps and/or network connections. Two known application-level attacks, namely, voice squatting and voice masquerading, impersonate voice-enabled devices to steal and eavesdrop on conversations. In addition, voice-enabled devices are susceptible to malware that provides attackers with access for controlling the devices.

Moreover, a physical layer attack can readily bypass conventional security algorithms thus providing an unchecked entry point to the system. Inaudible voice commands, for instance, can be injected on the physical layer of a voice-enabled device by exploiting the nonlinearity of the device's microphone. Dolphin, or ultrasound, attacks have demonstrated that voice-enabled devices can respond to inaudible ultrasound commands, assuming the ultrasonic waves are strong enough to propagate through windows and the like. Recently, laser pointers have been used for line-of-sight attacks on microphone-based devices.

### SUMMARY

Briefly, aspects of the present disclosure involve systems and methods for examining a vulnerability or loophole of voice-enabled devices (e.g. smart speakers and smart phones) against electromagnetic interference attacks. In an aspect, an optimized measurement/attack method can be employed to detect the insecurity of the voice-enable devices, which permits designers of such devices to improve their designs.

In an aspect, a method of operating a voice-enabled device with an inaudible electromagnetic interference (EMI) command comprises multiplying an audible voice command signal with a carrier signal to generate an amplitude-modulated signal and transmitting the amplitude-modulated signal at an attack angle to a voice-enabled device via an antenna. The carrier signal has a resonant frequency that is greater than an audible frequency of the voice command signal such that the amplitude-modulated signal is inaudible. During transmitting, the method includes varying either the resonant frequency of the carrier signal or the attack angle of the transmitted amplitude-modulated signal or both. The method further includes determining an amplitude of the amplitude-modulated signal as received by the voice-enabled device and identifying at least one of a sensitive frequency and a sensitive attack angle of the voice-enabled device based on the determined amplitude.

In another aspect, a system for testing a voice-enabled device comprises a voice command source generating an audible voice command signal, a signal generator generating a carrier signal having a variable resonant frequency, and a frequency mixer mixing the voice command signal with the carrier signal to generate an amplitude-modulated test signal. The resonant frequency of the carrier signal is greater than an audible frequency of the voice command signal such that the amplitude-modulated test signal is inaudible. The system also includes an antenna transmitting the amplitude-modulated test signal at a variable attack angle to a voice-enabled device. The resonant frequency of the carrier signal and/or the attack angle of the transmitted amplitude-modulated signal are varied and at least one of a sensitive frequency and a sensitive attack angle of the voice-enabled device is identified based on an amplitude of the amplitude-modulated test signal as received by the voice-enabled device.

In yet another aspect, a method of detecting operability of a voice-enabled device includes generating an audible voice command signal, multiplying the audible voice command signal with a carrier signal to generate an amplitude-modulated signal, and transmitting the amplitude-modulated signal at an attack angle to a voice-enabled device via an antenna. The carrier signal has a resonant frequency greater than an audible frequency of the human voice command signal such that the amplitude-modulated signal is inaudible. The method further includes, during transmitting, varying either the resonant frequency of the carrier signal or the attack angle of the transmitted amplitude-modulated signal or both and identifying at least one of a sensitive frequency and a sensitive attack angle at which the voice-enabled device optimally receives the inaudible amplitude-modulated signal based on an amplitude of the amplitude-modulated signal as received by the voice-enabled device.

Other objects and features will be in part apparent and in part pointed out hereinafter.

### BRIEF DESCRIPTION OF THE DRAWINGS

FIG. 1 illustrates a microphone circuit having electromagnetic interference coupled thereto according to an embodiment.

FIG. 2 illustrates a general attack setup according to an embodiment.

FIG. 3 illustrates a single-tone input and its model output according to an embodiment.

FIG. 4 illustrates a single-tone input with a DC offset and its model output according to an embodiment.

FIG. 5 illustrates a square-rooted single-tone input and its model output according to an embodiment.

FIG. 6 illustrates real voice command injection measurement according to an embodiment.

FIG. 7 illustrates a sensitive carrier signal frequency analysis for two different types of voice-enabled devices according to an embodiment.

FIG. 8 illustrates a transfer function of the sensitive location of a microphone according to an embodiment.

FIG. 9 illustrates a relationship between input and output power of a device under test according to an embodiment.

Corresponding reference characters indicate corresponding parts throughout the drawings.

### DETAILED DESCRIPTION

As described above, a voice-enabled device, such as a smart speaker or smartphone, is susceptible to attacks that could jeopardize security and privacy. Aspects of the present disclosure include operating a voice-enabled device with an inaudible electromagnetic interference (EMI) command. Operating the voice-enabled device in this manner provides insight into the device's vulnerability to attack. By identifying and detecting potential security weaknesses, manufacturers are better able to safeguard against such attacks.

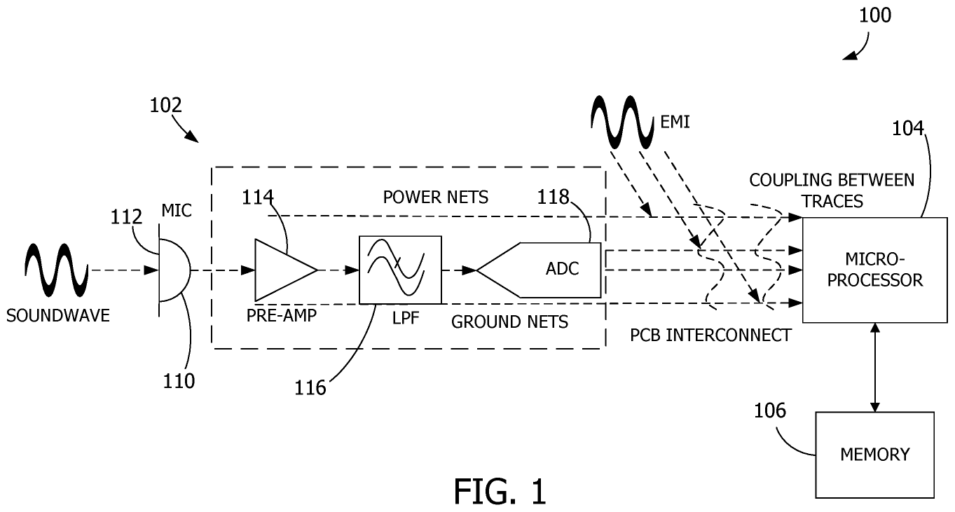

Referring now to FIG. 1, a voice-enabled device 100 includes a microphone 102 for receiving voice commands as well as a processor 104 and a memory 106. The memory 106 stores instructions that, when executed by the processor 104, implement an application layer of the voice-enabled device 100. The application layer, with software running on the voice-enabled device 100, makes critical decisions of the input data acquired by the microphone 102. An attacker can manipulate the data received by microphone 102 by injecting a voice command signal to the analog circuitry of microphone 102. The injected voice command passes an application layer algorithm such that it is recognized by voice-enabled device 100. Because voice-enabled device 100 trusts the readings of its own microphone 102, a physical attack using an injected voice command can bypass conventional security algorithms. In turn, voice-enabled device 100 executes the injected voice command from the attacker. In an embodiment, the voice command signal is inaudible to humans but audible to voice-enabled device 100. Generally, the human ear can receive audio signals having frequencies in the range of 20 Hz to 20 kHz whereas the microphone 102 of voice-enabled device 100 is capable of receiving audio signals outside this frequency range. Under these circumstances, an attack on the target voice-enabled device 100 would go unnoticed by a human. This is a critical security issue for such devices.

Although some voice-enabled devices can be set to recognize only the owner's voice, a record of the owner's voice may be available on the internet or elsewhere. Alternatively, the owner's voice can be constructed through deep learning. Software for recomposing the injected voice command in the owner's voice would overcome this security feature.

Referring further to FIG. 1, aspects of the present disclosure relate to investigating the sensitive vulnerable frequencies via an intentional EMI coupling mechanism. To model an induced nonlinearity of microphone 102, the working voice-enabled device 100 has electronic circuitry assumed to act as a receiving antenna. Electromagnetic waves couple to conductors on the device's printed circuit board (PCB), as shown by the broken lines in FIG. 1. In the illustrated embodiment, the microphone 102 of voice-enabled device 100 comprises a micro-electrical-mechanical system (MEMS)-based microphone sensor 110, having a membrane 112 through which sound waves are received, an amplifier 114, a low-pass filter (LPF) 116, and an analog-to-digital converter (ADC) 118. When the EMI signal is coupled onto the power/ground net and reaches the amplifier 114, the induced nonlinearity can be modeled by developing the output signal equations of a simple amplifier. The injection path of the EMI attack is different from the previous attacks such as ultrasound commands where the commands are injected through the membrane 112 of microphone 102. In this instance, the intentional EMI attacks are performed by injecting the signal to the electronic circuitry of the voice-enabled device 100, which has components that can couple the EMI signal efficiently from MHz to GHz depending on the resonant frequency of the receiving electronic circuitry. Once the EMI signal is coupled to the PCB, the traces on the PCB deliver the signal to microphone 102.

The acoustic waves passing through the microphone sensor 110 induce vibrations in membrane 112 and are processed by the rest of the circuitry. Most microphones are designed to only capture voice commands below 24 kHz. In the illustrated embodiment, amplifier 114 is used in the event the amplitudes of captured voice commands are too low to be processed by the ADC 118. The ADC 118 quantifies the signal levels with a sampling rate of, for example, twice the maximum voice signal frequency. The LPF 116 removes audio signals having frequencies greater than 24 kHz.

In operation, a nonlinearity is induced in the circuitry of microphone 102. The nonlinearity can be expressed by equation (1):

Sₒᵤₜ=aSᵢₙ+bSᵢₙ²+ . . . dSᵢₙ⁴+mSᵢₙⁿ (1)

where Sₒᵤₜ is the output signal of microphone 102 and Sᵢₙ is the input signal. In general, the coefficients of the higher-order terms decrease dramatically, with the coefficients m=c=b; hence, only the second-order coefficient needs to be considered for the nonlinearity. The attack signal, A cos ωᵢt, is multiplied with the carrier signal, B cos ωᵣt, to generate the amplitude-modulated signal:

$$A cos {ω}_{i} t \times B cos {ω}_{r} t = \frac{AB}{2} [ cos ( {ω}_{r} - {ω}_{i} ) t + cos ( {ω}_{r} + {ω}_{i} ) t ] \qquad ( 2 )$$

where A and B are the amplitude of the signals, ωᵢ=2πfᵢ and ωᵣ=2πfᵣ represent the angular frequency of the attack and carrier signals, fᵢ and fᵣ are the frequencies of the attack signal and carrier signal with relation fᵢ<<fᵣ. Due to the second-order term of (1), Sᵢₙ², the manipulated voice command will be shifted to the audible range as shown in (3). Since the carrier signal normally is a high-frequency signal which is removed by the LPF 116 in microphone 102. Therefore, only low-frequency components (voice signal) are presented as in (3):

$${( A cos {ω}_{i} t + B cos {ω}_{r} t )}^{2} \to \frac{{A}^{2} {B}^{2}}{4} cos 2 {ω}_{i} t \qquad ( 3 )$$

Assuming fᵢ is the voice command below 10 kHz in the audible range, after the nonlinear operation of microphone 102, low-frequency audible components up to 20 kHz containing the information of the voice command are generated. Because the spectrum of the audible output is doubled compared to the voice command, the voice command signal is preprocessed before it is modulated into the attack signal. In this manner, the exact voice command can be recovered after this nonlinearity of voice-enabled device 100.

In contrast to other types of attacks (e.g., ultrasound and light command, or laser pointer), attacks based on EMI can penetrate windows with relatively low loss and do not need to have the target in sight. The intentional EMI can be applied to inject information into analog devices that operate in the order of a few millivolts. This attack, known as “back-door” interfering, can easily affect a circuit. In an embodiment, the circuitry of microphone 102, which typically utilizes includes cables or copper PCB interconnects, is vulnerable to interference and allows information injection. For example, intentional EMI can attack the headset cable of a smartphone by injecting an audio signal through electromagnetic coupling on the cable because the cable acts as an antenna receiving the electromagnetic interference.

Aspects of the present disclosure include an intentional electromagnetic interference attack setup for voice-enabled device 100 using EMI. The EMI induces voltages on the order of a few millivolts on conductors, which are then converted to baseband signals by exploiting the inherent nonlinearity of microphone 102. The EMI signal is specially preprocessed to minimize the useless harmonics generation at the microphone output signals, which significantly improves the recognition rate as well as nullify the previous countermeasures based on the harmonics detection. The sensitive carrier frequency found by the method of the present disclosure improves the attack distance as well. A measurement-based methodology is applied to locate the sensitive regions for noise coupling without knowing the layout of the PCB, and the transfer function is also obtained to insure the main coupling location. As an example, experimental data shows that in open space, intentional EMI under 2.5 W can inject commands at distances up to 2.5 m on voice-enabled device 100.

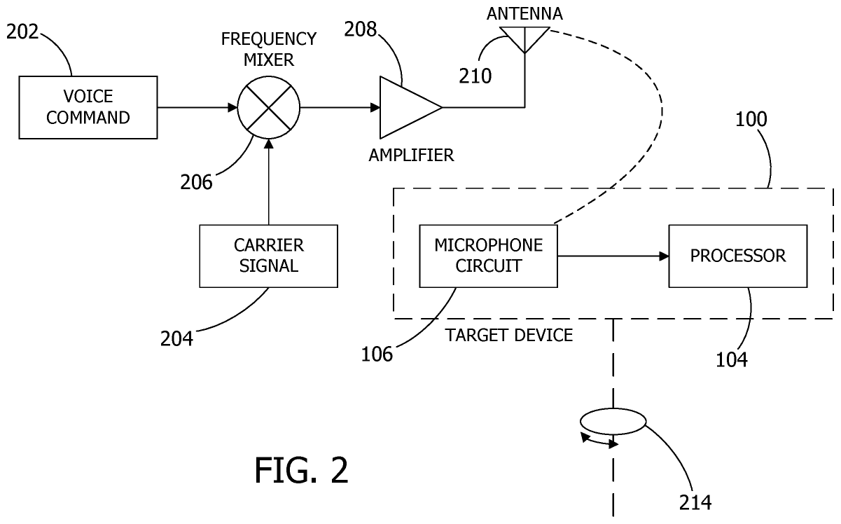

FIG. 2 shows a general setup of the attack. In an embodiment, a first signal generator 202, such as a computer, generates an audio attack voice signal and a second signal generator 204, such as a frequency synthesizer or vector network analyzer, generates a carrier signal. A mixer 206 is applied to mix/modulate the attack signal to the carrier signal depending on the sweeping frequency band. A power amplifier 208 amplifies the modulated signal. In the illustrated embodiment, a directional antenna 210 transmits the amplified modulated signal and radiates more power in the dedicated direction of the modulated signal toward the target voice-enabled device 100.

In an embodiment, the intended voice signal can be manipulated as shown in the Algorithm A by a computer. This manipulated signal can be saved to a smartphone, for example, and directly output through an auxiliary cable or imported to the audio signal generator 202. The other side of the aux cable can be connected to the mixer 206 to generate the amplitude-modulated signals (voice signal modulated to the carrier signal). As shown in FIG. 2, the output of mixer 206 is connected to the amplifier 208 and then connected to the antenna 210. The amplitude-modulated signals, which are inaudible, propagate to the target device 100 as the electromagnetic waves. The electromagnetic wave is captured by the circuitry in the target device and then demodulated to the voice signal due to the nonlinearity of microphone 102.

#Algorithm A

[S_v,Fs_v] = audioread(‘voice command.mp3’);%Read the reconstructed voice
command file
S_v=S_v+abs(min(S_v));%Add DC component to the reconstructed voice command
S_new=sqrt(S_v+abs(min(S_v)));%Square root of the previous case
%%
%Repeatly play the preprocessed voice command
while(1)

sound((S_new),Fs)%Play the preprocessed voice command
pause(3)%Give a pause which is equal to the length of the preprocessed

voice command in s
end

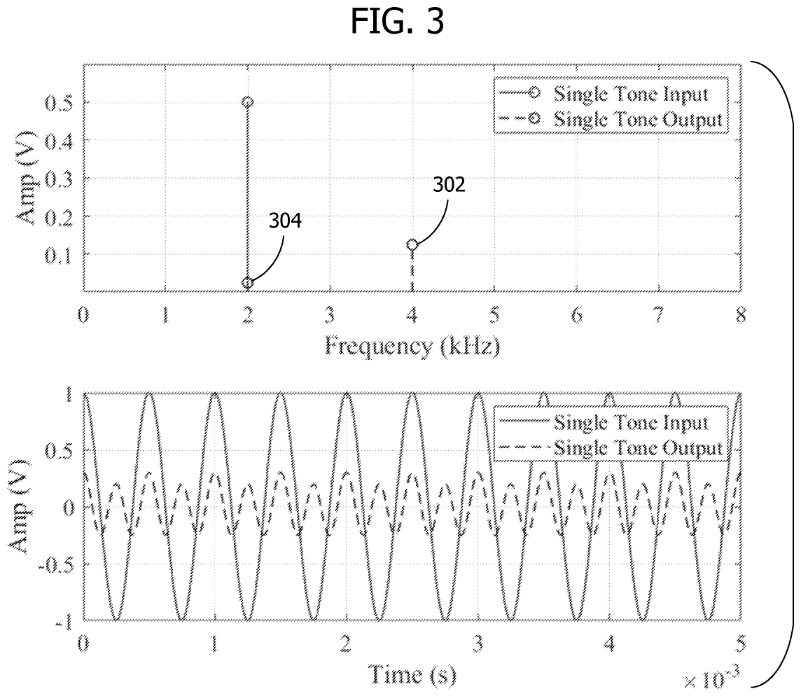

Aspects of the present disclosure relate to manipulation of an amplitude modulated attack signal. Regarding optimization of the attack signals, a single tone of 2 kHz audible signal, without any processing, is directly modulated to the carrier signal to implement the attack. A square function exhibiting nonlinear behavior is applied to the modulated signal. The resulting signal passes through the LPF 116 of microphone 102, and only the low-frequency components remain. Through the mathematical derivation, the low frequency component cos(ωᵢt) with fᵢ=2 kHz and cos(2ωᵢt) with 2fᵢ=4 kHz is found after LPF 116 as shown in the equation below:

$${( A cos {ω}_{i} t + B cos {ω}_{r} t + F cos {ω}_{r} t )}^{2} \to \frac{{A}^{2} {B}^{2}}{4} cos 2 {ω}_{i} t + ABF cos {ω}_{i} t \qquad ( 4 )$$

where cos(ωᵣt) is the feed-through component generated by mixer 206 due to the limited isolation of the mixer. The measurement of the modulated signal through mixer 206 exposed this feed-through component. And this component has been applied in the computations below. As shown in FIG. 3, the generated 4 kHz at 302 is much stronger than the 2 kHz output signal at 304. To recover the attack signal of 2 kHz after the microphone's nonlinearity, the preprocessing of the attack signal is performed. Therefore, the optimization of the attack signal needs to be performed.

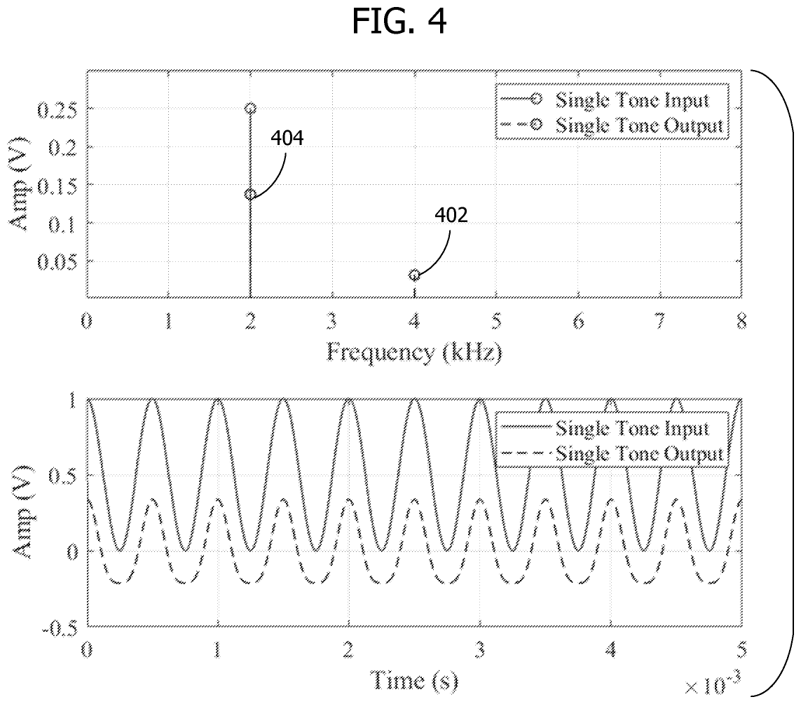

Aspects of the present disclosure further relate to DC added attack signal optimization. By adding a DC component to the attack signal, still using a 2 kHz signal as an example, the model output will change. As shown in (5) below, where C is the amplitude of the DC component, after LPF 116, both the cos ωᵢt and cos 2ωᵢt remain. The 4 kHz output signal at 402 and the 2 kHz output signal at 404 are shown in FIG. 4. But now the 2 kHz signal has a higher amplitude compared to the previous case. Notably, the time domain output waveform is deformed compared to the original signal waveform shown as the solid curve in FIG. 3.

$${( ( A cos {ω}_{i} t + C ) \times B cos {ω}_{r} t + F cos {ω}_{r} t )}^{2} \to \frac{{A}^{2} {B}^{2}}{4} cos 2 {ω}_{i} t + ( {ACB}^{2} + ABF ) cos {ω}_{i} t \qquad ( 5 )$$

To ensure that the coefficient of the cos 2ωᵢt component is much smaller than the coefficient of the cos ωᵢt component, as shown in (5), the relation in (6) can be developed:

$$\frac{{A}^{2} {B}^{2}}{4} = ( {ACB}^{2} + ABF ) ⇒ AB = 4 CB + 4 F \qquad ( 6 )$$

$$\frac{4 ( CB + F )}{AB} ? 1$$

should be the condition to minimize the cos 2ωᵢt component. Alternatively, the square-root signal, as shown below, is applied.

Aspects of the present disclosure relate to square-root attack signal optimization. Since the nonlinearity is represented as the square term as shown in (1), a square root of the signal can be first performed. Therefore, after the square function of the signal, the original signal can be recovered. Since the computer can only output the real number of the signals, the DC value is added first before square root to avoid generating complex values. Continuing to preprocess the attack signal, the operation shown by (7) can be performed:

$${( \sqrt{( A cos {ω}_{i} t + C )} \times B cos {ω}_{r} t + F cos {ω}_{r} t )}^{2} \to \frac{{A}^{2} {B}^{2}}{4} cos {ω}_{i} t + BF \sqrt{( A cos {ω}_{i} t + C )} \qquad ( 7 )$$

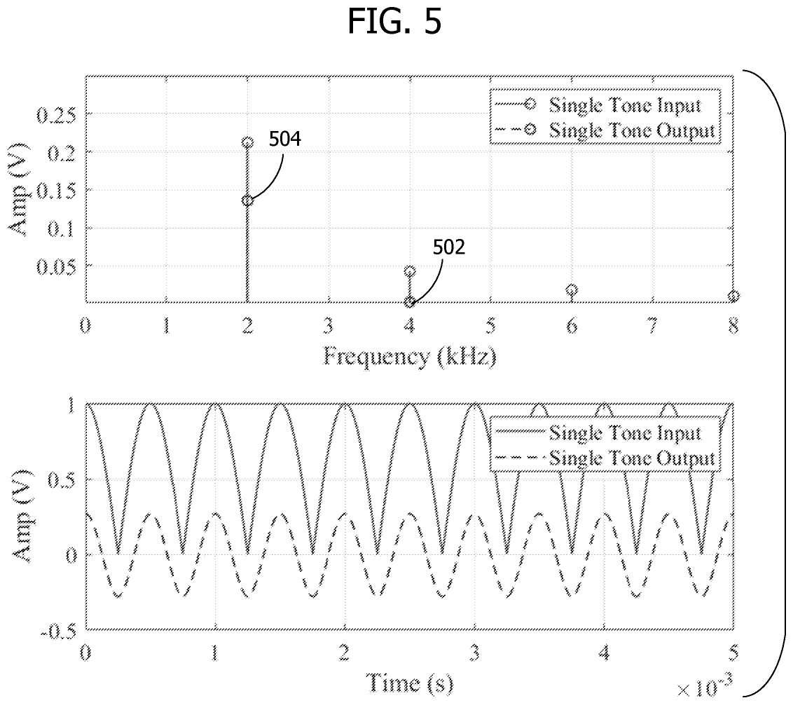

As shown in FIG. 5, by applying this operation to the attack signal, the cos 2ωᵢt signal (4 kHz) at 502 remains but it is much lower in amplitude and has less effect on the original signal, cos 2ωᵢt. The single tone output at 2 kHz is shown at 504. Moreover, the shape of the time domain output curve is well recovered compared with the DC added case. Therefore, the square-rooted injection signal is a better attack signal recovered in the voice-enabled device 100.

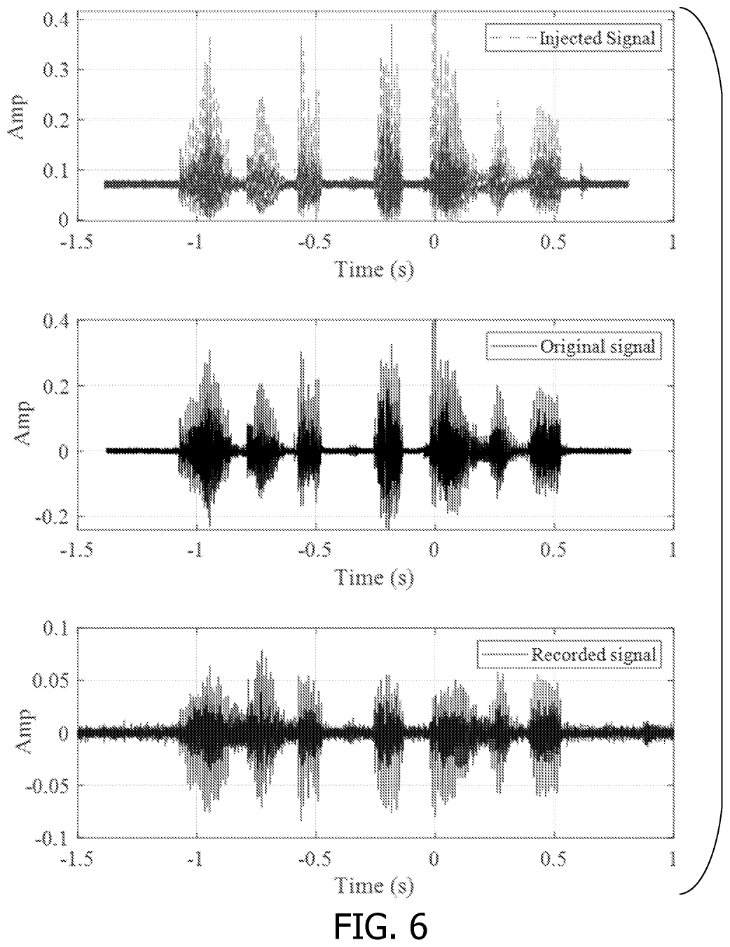

FIG. 6 illustrates measurement of a real voice command injection to be more confident on the attack signal preprocessing. The injected voice command is, for example, “What time is it?”, and the target device responded with the current time. The command was sending continuously. In FIG. 6, the recorded voice signal matches well with the original signal. The square-root function of the original signal was applied to form the attack signal, and the resulting signal was then injected to the target device to ensure better signal recovery in the recorded file. However, without preprocessing of the input signal, the target device 100 could not understand the voice command because the frequency of the signal changed due to the nonlinear effect.

At a maximum attack distance shown in Table I, target device 100 can barely recognize the voice command. Therefore, the efficiency of the different preprocessed attack signals can be analyzed with the peak-to-peak value normalized to 1. A comparison of recognition rates of the various preprocessed attack signals for different products are indicates that the square-rooted input has the best attack performance. The recognition rates are determined from the execution times of target device 100 over ten attacks for each preprocessed attack signal.

TABLE I
Maximum Attack Distance Based on Current Setup with Different Antennas

| Product | Smart Speaker 1 | | Smart Speaker 2 | | Smart Speaker 3 | | Cellphone 1 | |
|---|---|---|---|---|---|---|---|---|
| Maximum attack distance | 2.5 | m | 40 | cm | 40 | cm | 20 | cm |
| Minimum attack power | 2.94 | Watts/m | 39.3 | Watts/m | 39.3 | Watts/m | 157.2 | Watts/m |
| density | | | | | | | | |
| Minimum attack electrical | 150 | dBuV/m | 161.7 | dBuV/m | 161.7 | dBuV/m | 167.7 | dBuV/m |
| field intensity | | | | | | | | |

Aspects of the present disclosure can be applied to discover the exact sensitive frequency of the circuit in target device 100 and the sensitive attack angles. It can also be used to locate the area which generates the resonant frequency of target device 100 by comparing the received signal amplitude in the recorded files of target device 100. The target device 100 can then be optimized against the sensitive frequency and the voice command injection attack.

The setup used to find the sensitive frequency and angle is the same as in FIG. 2 with target device 100 positioned on a rotatable table 214. The single tone signal can be created by a computer executing, for example, Algorithm B shown below, or directly through use the low-frequency signal generator 202. In an embodiment, the carrier signal generator 204 is configured to vary the frequency of the carrier signal. For each frequency of the carrier signal, target device 100 is rotatable over 360 degrees, because the target device is rotated in two directions (θ,ϕ). The sensitive frequency and angle are found by comparing the amplitude of the audible single-tone test signal in the recorded file at different frequencies and angles of attack. Therefore, the voice signal modulated to the identified sensitive frequency can attack target device 100 more easily than at other frequencies.

#Algorithm B

%Single tone voice signal creation
Fs=100000;%Sampling rate
dt=1/Fs; %Signal time step
t= 0:dt:100;%Time steps - 100 time steps
S=(cos(pi*3500*t)); %Single tone signal at 3500Hz
audiowrite(‘Single_ tone_signal.wav’,S,Fs); %Write signal to voice file
[S,Fs] = audioread(‘Single_tone_signal.wav ’);%Read the voice file
sound(S,Fs);%Play the voice file

The most sensitive frequency of the carrier signal needs to be identified to have efficient energy coupled to the voice-enabled device 100. In addition, attacking at the sensitive frequency can increase both the attack distance and the success rate. The following process can be applied to find the most sensitive frequency of the carrier signal for implementing an attack on voice-enabled device 100. To find the sensitive frequency of the carrier signal:
(1) A single-tone audible signal (e.g., 2 kHz or another single tone signal within the audible frequency band) modulated to the carrier signal is applied for the attack for simplicity, because a real voice command is a signal with multiple tones, which is difficult to define the amplitude because there might be some other noise in the recorded file.
(2) Then, sweep the frequency of the carrier signal with the attack setup and send the modulated signal to the voice-enabled device 100 with an activation voice command to wake up the device. Alternatively, let the device 100 make a voice call to a phone which can record before sending the modulated signal.
(3) The record file can be downloaded from the cloud because most voice-enabled devices upload the voice command to the cloud automatically. Alternatively, the recorded file on the phone can be transferred to the computer for analysis.
(4) Finally, the recorded file can be analyzed through Fast Fourier Transform (FFT) to determine whether the frequency harmonic at 2 kHz are present. By comparing the amplitude of the harmonic at 2 kHz, the sensitive frequency can be determined.

The frequency of the carrier signal was swept from 1 GHz to 18 GHz with 1 GHz frequency step using the setup shown in FIG. 2. When the setup is fixed, the sweeping process was automated by programming the signal generator.

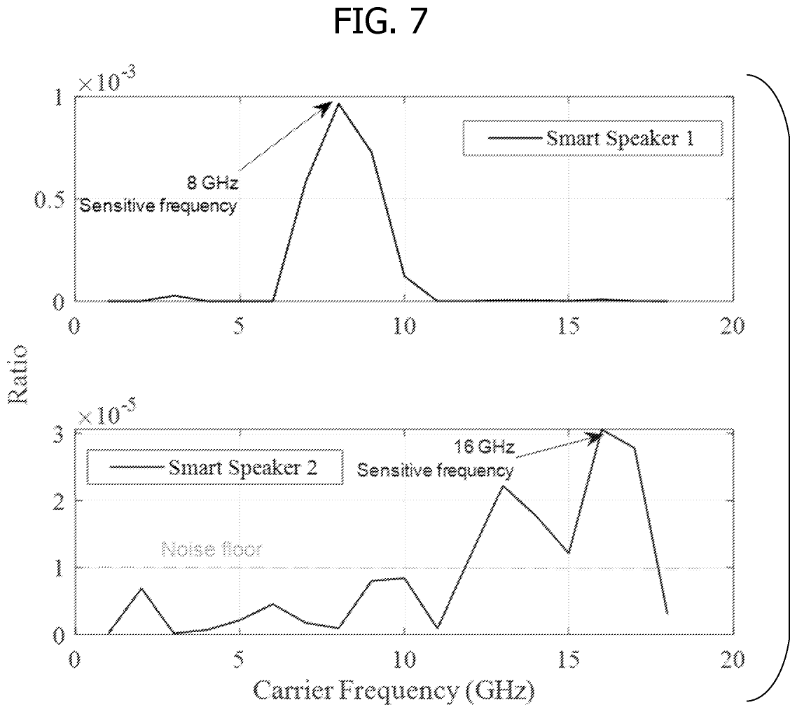

FIG. 7 shows the ratio of the power of the recorded 2 kHz component to the power of the attack signal at the antenna output for two different products, the ratio is representing the transfer function from the antenna output to the record file output. Four main propagation paths are included in this ratio: air propagation, coupling path, demodulation process, record file. The same distance, 50 cm for Smart Speaker 1, 20 cm for Smart Speaker 2, are maintained for the different frequencies of the carrier signal. The sensitive frequencies of these two products are obtained at 8 and 16 GHz, respectively. From the amplitude ratios of the two products, the Smart Speaker 1 is observed to be easily coupled at 8 GHz. Since the environmental noise may contain the audible signals that can be recorded by the devices, this may impact the final obtained results. Thus, the experiments need to be performed with in a quiet room to have reliable results. The sensitive carrier signal frequency is found at 16 GHz for the Smart Speaker 2. Although the ratio is very low, the attack still succeeded because the application layers of different voice-enabled devices have different decisions on the input signal level.

To apply a near field injection technique, a high-frequency field probe is used instead of antenna 210 to inject the modulated electromagnetic signal, which is different from the normal near field scan that measures the electromagnetic field component at a scanning location. Otherwise, the setup is the same as in FIG. 2. The injection area is where microphone 102 is located and when the 2 kHz magnitudes are received in the recorded file at different locations, the results indicate that the most sensitive location is near the microphone.

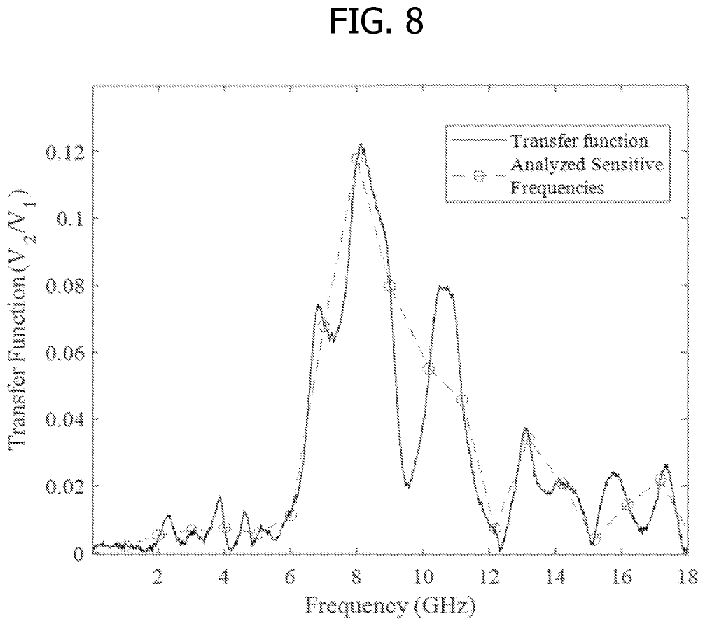

To support that the sensitive location results in the highest noise level coupled to microphone 102, the coupling path transfer function is obtained between the power pin of the microphone and the sensitive location. In an embodiment, a 2-port S parameter measurement setup of a device-under-test, i.e., target voice-enable device 100, can be used. The positive terminals of the two identical coaxial cables are soldered on the sensitive location and the power pin of microphone 102, and the negative terminals are soldered on the adjacent ground pins. According to an embodiment, the measured 2-port S parameter data is transformed into the ABCD matrix to obtain the transfer function as shown in FIG. 8. The plot in circles in FIG. 8 represents the analyzed sensitive frequencies in FIG. 7. It can be seen that the strongest coupling happens at around 8 GHz, which is consistent with the results shown in FIG. 7.

The maximum attack distances for different target devices determined experimentally are achieved with a square-rooted attack voice command. The maximum distance reached for Smart Speaker 1, for example, is 2.5 m with a parabolic antenna. For different products, varying maximum attack distances based on the current setup are obtained with different antennas, as shown in Table I. The maximum attack distance varied from 20 cm to 2.5 m for different target devices with an output power of only 2.5 W, and the antenna gain varies from 15 to 22 dBi. The attack distance can be increased by employing a high power amplifier.

In an embodiment, if the attack distance is fixed, different attack powers are applied to generate different electrical field densities in front of the device-under-test, i.e., target device 100. The power density in front of voice-enabled device 100 can be derived from the Friis transmission equation, as shown in (8):

$${P}_{D} = \frac{{P}_{t} {G}_{t}}{4 π {d}^{2}} \qquad ( 8 )$$

The electric field strength at a given location can be obtained as follows:

E=\sqrt{P_{D}Z₀}=\sqrt{120πP_{D}} (9)

where Pₜ is the transmitter power (either the peak or average power), Gₜ is the gain of antenna 210, d is the distance, and Z₀ is the air impedance. In this case, the electric field strength in front of the device 100 can be characterized. The minimum required power density and electrical field intensity in front of voice-enabled device 100 are listed in Table I.

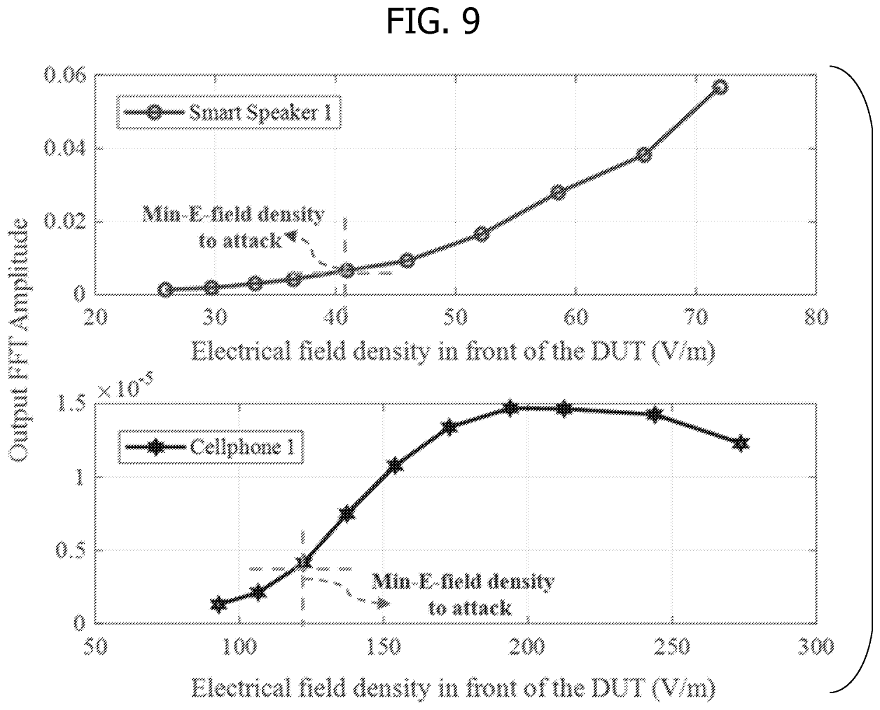

The gain of antenna 210 in an embodiment is 18 dBi at 8 GHz for the Smart Speaker 1 attack and 22 dBi at 18 GHz for the Cellphone 1 attack. The single-tone audible output spectrum is obtained in the recorded files. The relation between the E-field density in front of the device-under-test, i.e., target voice-enable device 100, and the obtained single-tone audible output is shown in FIG. 9. The dashed lines indicate the minimum E-field densities needed for different target devices 100 to recognize a real voice command. The different target devices 100 exhibit varying limits and coupling strengths; for example, to attack Smart Speaker 1, the required minimum E-field density in front of the device is around 40 V/m, with a distance of 20 cm. However, for Cellphone 1, the requirement is around 125 V/m. In addition, the recognition level varies due to the noise cancellation technique applied by the Cellphone 1. The coupling efficiency which is the ratio between the input and output power can be obtained by calculating the slope of the curve.

Aspects of the present disclosure relate to an optimized electromagnetic attack process and sensitivity analysis. The mechanism of the nonlinearity in the circuit of microphone 102 is disclosed. The attack signal is preprocessed to increase the probability of a successful attack based on the nonlinearity characteristics, and measurements are performed for the single-tone signal attack to illustrate the effectiveness of the attack signal preprocessing. In addition, a methodology for sensitivity frequency analysis is disclosed in order to find the most sensitive carrier frequency of a given product. The coupling sensitivity is studied based on near field injection technique, and the transfer function from the sensitive location to the microphone 102 under test is measured. The real voice commands are also successfully injected and executed by the target devices 100. Different maximum distances have been reached for different target devices 100. Generally, the maximum distance is depending on the output power of antenna 210 and types of device-under-test. A model can be built to estimate the required attack power (output power from antenna 210 or the power density in front of device 100). Thus, a designer can optimize device 100 based on their standards regarding attackable distance and power.

Countermeasures for reducing the risk of an attack include layout optimization, shielding, and detection of inaudible voice commands. Most electromagnetic threats arise due to an unintentional antenna structure associated with the PCB layout design. Additional efforts to minimize exposed traces in the outer layers can reduce electromagnetic coupling. Moreover, the unintentional antenna structure near the microphone can act as an antenna to receive the intentional EMI signal and conduct it to the microphone, allowing the microphone to demodulate the voice command. Also, because the electromagnetic field must travel to the microphone circuit, a full structure shielding technique can be integrated into the device by exposing only the necessary parts, for example, by including a small hole for the microphone. An outer metal shield will prevent the field from coupling to the interconnects of the microphone circuit. Although the cost will increase, security risks can be minimized. Radio frequency (RF) modulated signals operate at high frequencies; thus, another circuit can be added to detect the high-frequency component, in parallel to the microphone circuit. If modulated RF signals are detected, the circuit can give a signal to the microphone to stop listening. Thus, the smart device will not execute the attack command.

Embodiments of the present disclosure may comprise a special purpose computer including a variety of computer hardware, as described in greater detail below.

For purposes of illustration, programs and other executable program components may be shown as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and process without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A method of operating a voice-enabled device with an inaudible command, the voice-enabled device configured to receive and respond to an audible voice command, the method comprising:
multiplying an audible voice command signal with a carrier signal to generate an amplitude-modulated signal, wherein a resonant frequency of the carrier signal is greater than an audible frequency of the voice command signal such that the amplitude-modulated signal is inaudible;
transmitting the amplitude-modulated signal at an attack angle to a voice-enabled device via an antenna;
during transmitting, varying either the resonant frequency of the carrier signal or the attack angle of the transmitted amplitude-modulated signal or both; and
identifying one or more operating characteristics of the voice-enabled device based on the amplitude modulated signal.

2. The method of claim 1, further comprising pre-processing the voice command signal before multiplying the voice command signal with the carrier signal.

3. The method of claim 2, wherein pre-processing voice command signal comprises one or more of the following: adding a direct current (DC) offset to the voice command signal; and performing a square root function on the voice command signal.

4. The method of claim 1, wherein varying the attack angle of the transmitted amplitude-modulated signal comprises rotating the voice-enabled device during transmitting.

5. The method of claim 1, further comprising amplifying the amplitude-modulated signal before transmitting to the voice-enabled device via the antenna.

6. The method of claim 1, further comprising amplifying the carrier signal before multiplying the voice command signal with the carrier signal.

7. The method of claim 1, wherein the audible voice command signal comprises a single tone audible signal and further comprising:
determining an amplitude of the single tone audible signal in the amplitude-modulated signal as received by the voice-enabled device; and
identifying at least one of a sensitive frequency and a sensitive attack angle of the voice-enabled device based on the determined amplitude.

8. A system for testing a voice-enabled device, the voice-enabled device configured to receive and respond to an audible voice command, the system comprising:
a voice command source generating an audible voice command signal;
a signal generator generating a carrier signal having a variable resonant frequency, wherein the resonant frequency of the carrier signal is greater than an audible frequency of the voice command signal;
a frequency mixer mixing the voice command signal with the carrier signal to generate an amplitude-modulated test signal, wherein the amplitude-modulated test signal is inaudible; and
an antenna transmitting the amplitude-modulated test signal at a variable attack angle to a voice-enabled device;
wherein the resonant frequency of the carrier signal and/or the attack angle of the transmitted amplitude-modulated signal are varied.

9. The system of claim 8, further comprising:
a processor; and
a memory device storing processor-executable instructions that, when executed, configure the processor to pre-process the voice command signal before the voice command signal is mixed with the carrier signal.

10. The system of claim 9, wherein the memory device stores processor-executable instructions that, when executed, further configure the processor to add a direct current (DC) offset to the voice command signal and/or perform a square root function on the voice command signal.

11. The system of claim 8, further comprising a turntable configure to rotate the voice-enabled device for varying the attack angle of the transmitted amplitude-modulated signal.

12. The system of claim 11, wherein the turntable is rotatable through 360 degrees.

13. The system of claim 8, further comprising a power amplifier amplifying the amplitude-modulated signal before the amplitude-modulated signal is transmitted to the voice-enabled device via the antenna.

14. The system of claim 8, further comprising a pre-amplifier amplifying the carrier signal before the voice command signal is mixed with the carrier signal.

15. The system of claim 8, wherein the audible voice command signal comprises a single tone audible signal and wherein at least one of a sensitive frequency and a sensitive attack angle of the voice-enabled device is identified based on an amplitude of the single tone audible signal in the amplitude-modulated test signal as received by the voice-enabled device

16. A method of detecting operability of a voice-enabled device by an inaudible command, the voice-enabled device configured to receive and respond to an audible voice command, the method comprising:
generating an audible voice command signal;
multiplying the audible voice command signal with a carrier signal to generate an amplitude-modulated signal, wherein a resonant frequency of the carrier signal is greater than an audible frequency of the voice command signal such that the amplitude-modulated signal is inaudible;
transmitting the amplitude-modulated signal at an attack angle to a voice-enabled device via an antenna;
during transmitting, varying either the resonant frequency of the carrier signal or the attack angle of the transmitted amplitude-modulated signal or both; and
identifying at least one of a sensitive frequency and a sensitive attack angle at which the voice-enabled device optimally receives the inaudible amplitude-modulated signal.

17. The method of claim 16, wherein generating the audible voice command signal comprises generating a single tone audible signal.

18. The method of claim 17, further comprising recording the amplitude-modulated signal as received by the voice-enabled device while the resonant frequency of the carrier signal and/or the attack angle of the transmitted amplitude-modulated signal are varied.

19. The method of claim 18, wherein identifying the at least one of a sensitive frequency and a sensitive attack angle comprises analyzing the recorded amplitude-modulated signal to identify frequency harmonics of the single tone audible signal.

20. The method of claim 16, further comprising performing a square root function on the audible voice command signal to pre-process the audible voice command signal before multiplying the audible voice command signal with the carrier signal.
